(19) United States
(12) Patent Application Publication
(10) Pub. No.: US 2010/0171234 A1
(43) Pub. Date: Jul. 8, 2010

(54) COMPOSITION FOR MOBILE PHONE CASE AND METHOD OF MANUFACTURING MOBILE PHONE CASE USING THE SAME

(75) Inventors: Jong Young LEE, Suwon (KR); Yongsoo OH, Seongnam (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/555,410

(22) Filed: Sep. 8, 2009

(30) Foreign Application Priority Data
Jan. 7, 2009 (KR) 10-2009-0001192

(51) Int. Cl. B29C 45/16; C08K 3/10

(52) U.S. Cl. 264/129; 524/413; 524/435; 264/328.8; 264/241

(57) ABSTRACT

There are provided a composition for mobile phone cases and a method of manufacturing a mobile phone case using the same. The composition comprises 70 to 97% by weight of a thermoplastic resin selected from the group consisting of polycarbonate (PC), acrylonitrile-butadiene-styrene (ABS), polybutyrene terephtalate (PBT), acrylic resin and combinations thereof; and 3 to 30% by weight of ferrite selected from the group consisting of nickel-zinc ferrite, manganese-magnesium ferrite, manganese-zinc ferrite, copper-zinc ferrite, manganese-magnesium-aluminum ferrite, yttrium iron garnet (YIG) ferrite and combinations thereof, wherein the composition is a pellet resin formed by extruding the thermoplastic resin and the ferrite at a high temperature of 160 to 290° C.

### CROSS-REFERENCE TO RELATED APPLICATIONS

This application claims the priority of Korean Patent Application No. 10-2009-0001192 filed on Jan. 7, 2009, in the Korean Intellectual Property Office, the disclosure of which is incorporated herein by reference.

### BACKGROUND OF THE INVENTION

1. Field of the Invention

The present invention relates to a composition for a mobile phone case and a method of manufacturing a mobile phone case using the same, and more particularly, to a composition for a mobile phone case which is capable of effectively absorbing electromagnetic waves generated in a mobile phone in order to minimize their damage to human beings, and a method of manufacturing a mobile phone case using the same.

2. Description of the Related Art

It is easy for us to use mobile phones due to their mobility, but excessive electromagnetic waves generated in the use of the mobile phones may adversely affect human health, and, in turn, potentially may cause disease such as cancer.

In order to shield mobile phone users from electromagnetic waves generated by mobile phones, an electromagnetic interference (EMI) process was performed in this method by using a mobile phone case which is produced by injection-molding a polymer resin such as polycarbonate, and spraying or plating an inner layer of the mobile phone case with a conductive material. However, the conventional EMI process has problems of high manufacturing costs and product inferiority rate because it is carried out in 5 or 6 complicated steps.

The EMI process also has the problem of generating waste products such as coating by-products containing volatile organic compounds or heavy metals, which cause environmental pollution. In particular, the spray coating method has a problem in that volatile organic compounds may be formed during manufacturing of mobile phone cases, and, in turn, may cause disease such as argyria in human beings.

Furthermore, when a mobile phone case produced through the EMI process is used in a mobile phone, the mobile phone may fail to work properly due to the internal reflection of electromagnetic waves by a conductive material coated or plated on an inner surface of the mobile phone case. In order to reduce the internal reflection of electromagnetic waves, the mobile phone requires additional parts, which leads to high manufacturing costs and an increased product inferiority rate.

Therefore, the development of a novel material for mobile phone cases and a novel method of manufacturing a mobile phone cases is required to solve the foregoing problems.

### SUMMARY OF THE INVENTION

The present invention is designed to solve the problems of the prior art, and therefore it is an object of the present invention to provide a composition for mobile phone cases which are capable of effectively reducing the specific absorption rate (SAR) of electromagnetic waves generated by mobile phones without undergoing a multi-step process, and a method of manufacturing a mobile phone case using the same.

It is another object of the present invention to provide a composition for mobile phone cases which are capable of minimizing loss of call sensitivity and manufacturing light-weight case products by using a minimal amount of a ferrite, because ferrite having a predetermined initial permeability is used so that the composition can have an absorption frequency band that is optimized according to the kinds of final products it will be used with.

According to an aspect of the present invention, there is provided a composition for mobile phone cases including 70 to 97% by weight of a thermoplastic resin selected from the group consisting of polycarbonate (PC), acrylonitrile-butadiene-styrene (ABS), polybutyrene terephtalate (PBT), acrylic resin and combinations thereof; and 3 to 30% by weight of ferrite selected from the group consisting of nickel-zinc ferrite, manganese-magnesium ferrite, manganese-zinc ferrite, copper-zinc ferrite, manganese-magnesium-aluminum ferrite, yttrium iron garnet (YIG) ferrite and combinations thereof. In this case, the composition for mobile phone cases may be a pellet resin. Also, the pellet resin may be formed by extruding the thermoplastic resin and the ferrite at a high temperature of 160 to 290° C.

Meanwhile, the ferrite may have an initial permeability of 100μ to 1000μ.

Also, the composition may further include 0.1 to 10% by weight of an elastomer, in addition to the thermoplastic resin and the ferrite.

According to another aspect of the present invention, there is provided a method of manufacturing a mobile phone case. Here, the method includes: preparing a pellet resin composition by extruding a thermoplastic resin and a ferrite at a high temperature; and injection-molding the pellet resin composition at a temperature of 180 to 310° C.

In this case, the method of manufacturing a mobile phone case may further include: coating an outer layer of the mobile phone case with a polymer resin having an anti-static effect and/or colors after the injection molding step.

According to still another aspect of the present invention, there is provided a method of manufacturing a mobile phone case. Here, the method includes: preparing a thermoplastic resin composition used to form an outer layer of a mobile phone case; preparing a pellet resin composition used to form an inner layer of the mobile phone case by extruding 97 to 70% by weight of a thermoplastic resin and 3 to 30% by weight of a ferrite at a high temperature of 160 to 290° C.; and subjecting the thermoplastic resin composition and the pellet resin composition to a double injection molding process.

In this case, the thermoplastic resin composition used to form the outer layer of the mobile phone case may include an antistatic agent, a pigment or a combination thereof.

When the thermoplastic resin composition used to form an outer layer of the mobile phone case is transparent, the mobile phone case may be integrally with a window in the double injection molding step.

Furthermore, the double injection molding may be carried out at a temperature of 180 to 310° C.

### BRIEF DESCRIPTION OF THE DRAWINGS

In the above and other aspects, features and other advantages of the present invention will be more clearly understood from the following detailed description taken in conjunction with the accompanying drawings, in which:

FIG. 1 is a graph illustrating an electromagnetic shielding efficiency of a Ni—Zn ferrite having an initial permeability of 400μ.

FIG. 2 is a graph illustrating the electromagnetic shielding efficiency of a Ni—Zn ferrite having an initial permeability of 850μ.

FIG. 3 is a graph illustrating the electromagnetic shielding efficiencies of ferrites having initial permeabilities of 125μ, 400μ and 850μ, respectively, where the ferrites are mixed in a polymer resin.

FIG. 4 is a graph illustrating the electromagnetic shielding efficiency of a ferrite having an initial permeability of 1700μ, which is mixed in a polymer resin.

FIG. 5 is a photograph illustrating a mobile phone case manufactured by a method according to one exemplary embodiment of the present invention.

### DETAILED DESCRIPTION OF THE PREFERRED EMBODIMENT

Exemplary embodiments of the present invention will now be described in detail with reference to the accompanying drawings.

First, a composition for mobile phone cases according to one exemplary embodiment of the present invention will be described in detail.

The composition for mobile phone cases according to one exemplary embodiment of the present invention includes 70 to 97% by weight of a thermoplastic resin and 3 to 30% by weight of a ferrite.

In this case, thermoplastic resins that may be used as materials of the mobile phone case are generally used as the thermoplastic resin, and, for example, include polycarbonate (PC), acrylonitrile butadiene styrene (ABS), polybutyrene terephtalate (PBT), acrylic resin and the like, and they may be used alone or in combinations thereof.

Also, the ferrite includes, but is not particularly limited to, nickel-zinc ferrite, manganese-magnesium ferrite, manganese-zinc ferrite, copper-zinc ferrite, manganese-magnesium-aluminum ferrite, yttrium iron garnet (YIG) ferrite, and they may be used alone or in combinations thereof. In this case, the ferrite preferably has a particle size of approximately 0.01 to 30 μm, and preferably has a content of approximately 3 to 30% by weight. When the content of the ferrite is less than 3% by weight, the electromagnetic shielding effect may be insignificant. On the contrary, when the content of the ferrite exceeds 30% by weight, the impact strength may be degraded and call sensitivity may be poor.

The composition for a mobile phone case according to one exemplary embodiment of the present invention, which includes the thermoplastic resin and the ferrite, functions to get rid of electromagnetic waves by absorbing magnetic waves with the loss in the native magnetic property of the ferrite and converting the absorbed magnetic waves into mild heat.

In general, the method to shield electromagnetic waves includes a method of reflecting electromagnetic waves and a method of absorbing electromagnetic waves. Conventional methods of coating or plating a conductive material use a mechanism of reflecting an electric wave in electromagnetic waves. In this case, a magnetic wave is not intercepted by this mechanism. Since a mobile phone may fail to work properly due to the reflected electromagnetic waves, it requires additional parts to prevent erroneous operations of the mobile phone. On the contrary, in order to shield mobile phone users from electromagnetic waves, the present invention uses a method of absorbing a magnetic wave using a ferrite. Therefore, the method of the present invention reduces the possibility of the erroneous operation of mobile phones, compared to the conventional methods. As a result, the mobile phones according to one exemplary embodiment of the present invention do not require an additional part in order to prevent erroneous operations. In addition, since the method of the present invention is used to absorb a magnetic wave but intercept an electric wave, it has the beneficial effect of reducing SAR much more than the conventional methods of merely shielding an electric wave.

Meanwhile, the composition according to one exemplary embodiment of the present invention may use ferrite having a predetermined permeability to selectively absorb or remove a frequency of a certain bandwidth.

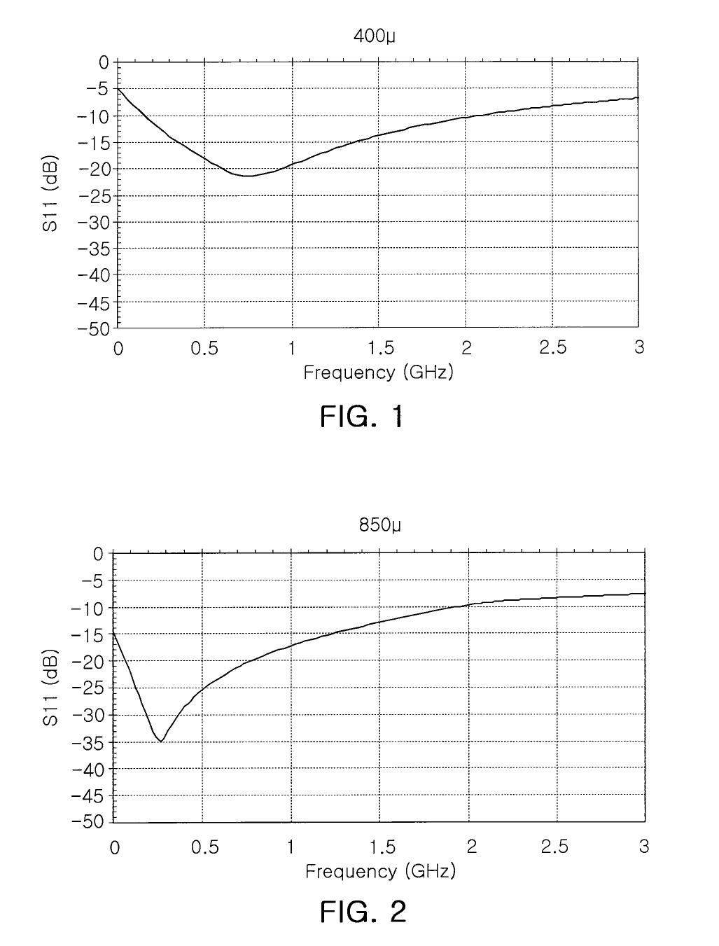

Ferrites have the characteristic that their magnetic absorption ranges and absorption capabilities are varied according to their initial permeability. FIGS. 1 and 2 are graphs illustrating properties of the ferrites, that is, the reduction in electromagnetic waves by ferrites having different initial permeabilities. FIG. 1 shows the properties of a Ni—Zn ferrite having an initial permeability of 400μ, and FIG. 2 shows the properties of a ferrite having an initial permeability of 850μ. As shown in FIGS. 1 and 2, it is revealed that the ferrite having an initial permeability of 400μ shows the beneficial effect of absorbing electromagnetic waves at a frequency range of 0.5 to 1 GHz, while the ferrite having an initial permeability of 850μ shows the beneficial effect of absorbing electromagnetic waves at a frequency range of 0.25 to 0.5 GHz. Since the ferrites have different magnetic absorption ranges and absorption capabilities according to the initial permeability, the electromagnetic shielding effect at a desired frequency bandwidth may be maximized by selective use of a ferrite having a suitable initial permeability in consideration of the frequency of product use, etc. In this case, the electromagnetic shielding effect may be sufficiently achieved by using a small amount of ferrite, which renders it possible to decrease the amount of the ferrite used. Considering the recent tendency towards manufacturing ever more lightweight mobile phones in order to facilitate their mobility and portability, it is advantageous to reduce the amount of the ferrite used as metal powders.

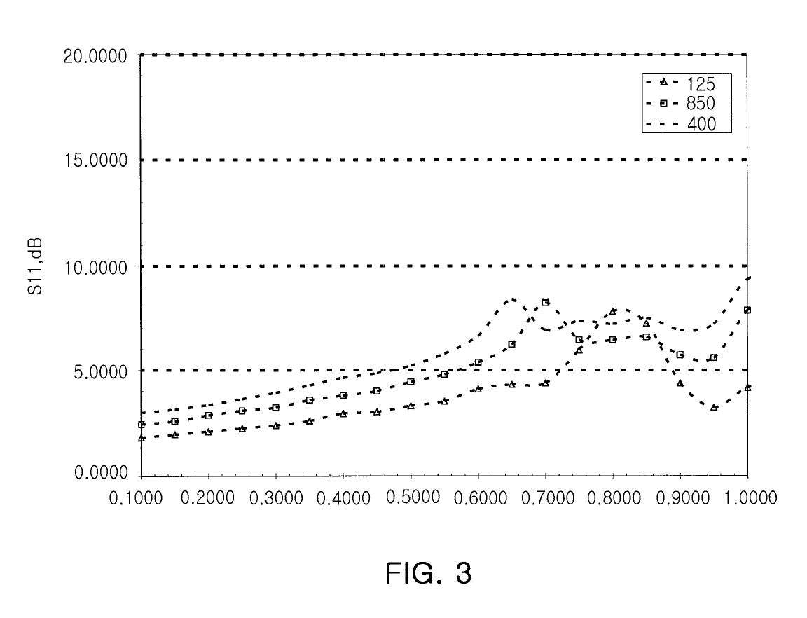

FIG. 3 is a graph illustrating the absorption capability of electromagnetic waves by a composition including a polymer resin and a ferrite. The graph shows the electromagnetic shielding efficiencies of test samples that are formed into toroidal shapes by mixing ferrites having initial permeabilities of 125μ, 400μ and 850μ, respectively, with a polymer resin. As shown in FIG. 3, it is revealed that when the ferrite is mixed with a polymer resin, its absorption frequency bandwidth is highly different from that of a ferrite which is used alone.

Meanwhile, an initial permeability of the ferrite included in the composition according to one exemplary embodiment of the present invention is preferably in a range of approximately 100 to 1000μ, considering that a communication frequency band of the recent widely used mobile phones is in a range of 800 to 900 MHz. As shown in FIG. 3, it can be seen that when a ferrite having an initial permeability of 100 to 1000μ is mixed with a polymer resin, the composition has excellent absorption effect in the vicinity of the communication frequency band, for example, 800 to 900 MHz, of mobile phones.

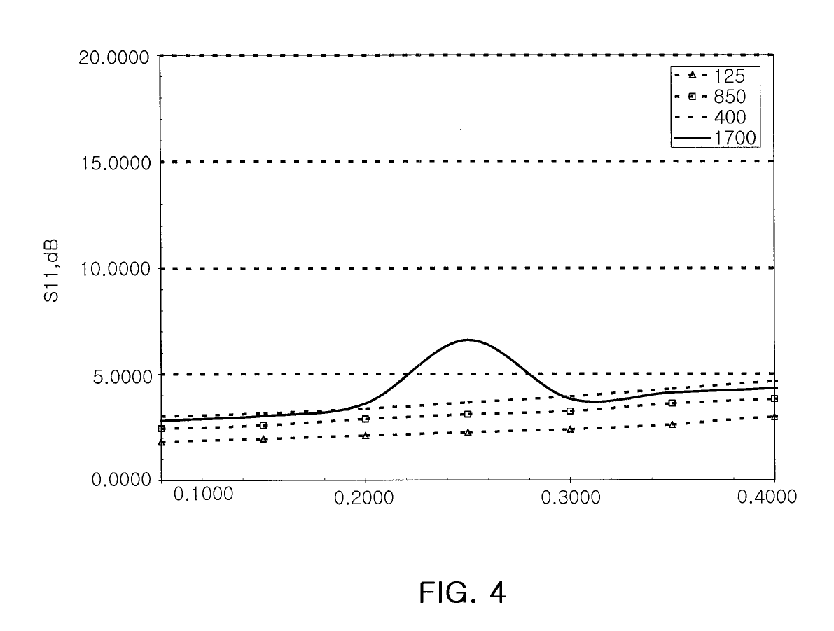

As shown in FIG. 4, it can also be seen that the composition including a ferrite having an initial permeability of 1700μ shows excellent absorption properties at a frequency band of 200 to 300 MHz. Since the commercial frequency of recently used wireless telegraphs is in a range of 200 to 450 MHz, it is considered that a composition including a ferrite having an initial permeability of 1700μ may be used to effectively manufacture wireless telegraph cases.

Meanwhile, the composition according to one exemplary embodiment of the present invention may further comprise 0.1 to 10% by weight of an elastomer in addition to the thermoplastic resin and the ferrite, when necessary. The elastomer is added to improve the strength of mobile phone cases. In general, the impact strength of the composition may deteriorate when metal powders such as ferrites are added to the thermoplastic resin. Therefore, the durability of mobile phone cases may be of a low level when they are manufactured using the composition. Accordingly, the elastomer is preferably added to the composition to improve the durability of final products. According to the experiments, it is revealed that, when the elastomer is added to the composition, the composition shows an improved impact strength by the minimum of 10%, compared to the elastomer-free composition.

Meanwhile, the composition according to one exemplary embodiment of the present invention is preferably manufactured into a pellet resin in order to facilitate the homogeneous mixing of the thermoplastic resin and the ferrite and to do easy handling. The pellet resin may be formed by extruding a thermoplastic resin and a ferrite at a high temperature of 160 to 290° C.

When the composition according to one exemplary embodiment of the present invention is used to manufacture a mobile phone case, the mobile phone case may have the excellently beneficial effect of shielding electromagnetic waves while minimizing the loss in call sensitivity by employing a ferrite having a predetermined initial permeability to selectively absorb a certain frequency range. Also, the composition for mobile phone cases may highly contribute to manufacturing light-weight products because the composition has the excellent effect of reducing SAR due to the selective frequency absorption of the ferrite, even when a small amount of the ferrite is used in the composition.

In addition to the above-mentioned advantageous effect, the composition may have an antibacterial effect owing to the presence of a cationic ferrite when the composition is used to manufacture mobile phone cases.

According to the experimental results, it is reported that various populations of bacteria live in mobile phones because the mobile phones are often kept under such suitable conditions (such as high temperature and high moisture) that bacteria live and grow in hands or in bags, and due to the exothermic characteristics caused during the mobile phone calls. It has been known that various bacteria including Staphylococcus and Streptococcus live and grow on mobile phones. However, if the composition according to one exemplary embodiment of the present invention is used to manufacture a mobile phone, it is possible to prevent the surface of the mobile phone case from being contaminated by bacteria. This is because the cationic ferrite included in the composition has an antibacterial effect.

The method of manufacturing a mobile phone case according to one exemplary embodiment of the present invention is described in more detail.

The method of manufacturing a mobile phone case according to one exemplary embodiment of the present invention includes: preparing a pellet resin composition by extruding a thermoplastic resin and a ferrite at a high temperature; and injection-molding the pellet resin composition.

In this case, the high temperature extrusion is preferably carried out at a temperature of 160 to 290° C. to prepare the pellet resin composition.

Meanwhile, the injection molding, which is carried out to form the composition into shapes of products, is preferably carried out at a temperature of 180 to 310° C. Injection molding methods have been well-known in the art, and the injection molding according to the present invention may be carried out according to conventional molding.

Meanwhile, in order to endow products with an anti-static effect and/or appearance of products with colors, the method of manufacturing a mobile phone case according to one exemplary embodiment of the present invention may further include: coating an outer layer of a mobile phone case, formed after the injection molding step, with a polymer resin including functional additives such as an anti-static agent and/or a pigment. When the coating step is carried out as described above, it is possible to interrupt the electromagnetic waves more effectively, to realize smoother appearances of products by endowing colors with the products, and to protect mobile phone cases from scratches, etc.

The coating step may be carried out by adding an anti-static agent and/or a pigment, a curing agent and the like to an adhesive polymer resin such as acryl to form a coating solution, applying the coating solution to the surface of an injection-molded mobile phone case and curing the applied coating solution by exposing the coating solution to ultraviolet rays (UV) or heat. The use of a heat curing process is desirable when the improvement of the electrical conductivity is necessary to improve antistatic performance. On the contrary, the use of an ultraviolet curing process is desirable when the hardness is preferentially considered to improve scratch resistance.

In addition to the above-mentioned curing processes, the method of manufacturing a mobile phone case according to one exemplary embodiment of the present invention may be performed in a double injection molding process where a different kind of resin is applied as an inner layer and an outer layer of the mobile phone case. The method of manufacturing a mobile phone case using the double injection molding includes: preparing a thermoplastic resin composition used to form an outer layer of a mobile phone case; preparing a pellet resin composition used to form an inner layer of the mobile phone case by extruding 70 to 97% by weight of a thermoplastic resin and 3 to 30% by weight of a ferrite at a high temperature of 160 to 290° C.; and subjecting the thermoplastic resin composition and the pellet resin composition to a double injection molding process.

In this case, the thermoplastic resin used to form the outer layer of the mobile phone case includes polycarbonate (PC), acrylonitrile butadiene styrene (ABS), polybutyrene terephtalate (PBT), acrylic resin and the like, and they may be used alone or in combinations thereof. Also, as the pellet resin composition used to form the inner layer of the mobile phone case, the composition according to one exemplary embodiment of the present invention, that is, the pellet resin composition, which is prepared by extruding a thermoplastic resin and a ferrite at a high temperature, is used.

Meanwhile, the thermoplastic resin used to form the outer layer may further include an antistatic agent and/or a pigment. When the antistatic agent and/or the pigment is added to the thermoplastic resin to form an outer layer of the mobile phone case, the appearance of products may be endowed with an antistatic effect and/or colors without undergoing an additional process such as surface coating.

Meanwhile, when a transparent resin is used as the thermoplastic resin used to form the outer layer of the mobile phone case, the mobile phone case may be formed integrally with a window (an image display window). Therefore, it is possible to omit a window assembly process which is carried out after the manufacture of the mobile phone case. When the mobile phone case is formed integrally with the window (an image display window) as described above, the omission of the window assembly process makes it possible to decrease the mechanical difficulties, which are caused by the penetration of foreign bodies and moisture through gaps between conventional mobile phone cases and windows, and to improve the productivity of the products as well, which leads to improved durability of the final products.

### EXAMPLES

Hereinafter, exemplary embodiments of the present invention are described in more detail.

### Preparative Example

95% by weight of a polycarbonate resin and 5% by weight of a Ni—Zn ferrite having an initial permeability of 400μ were put into an extruder, and extruded at 180 to 250° C. to prepare a pellet resin.

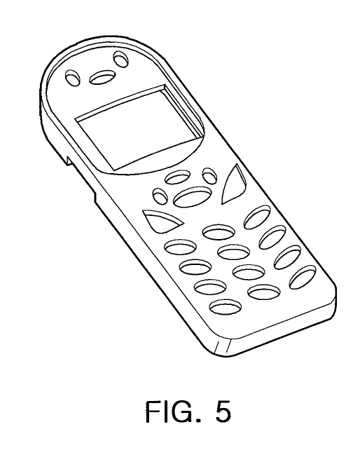

A mobile phone case as shown in FIG. 5 was manufactured by injecting the prepared pellet resin on the conditions as listed in the following Table 1.

TABLE 1

| | | |
|---|---|---|
| Cylinder | Front | 250~290° C. |
| temperature | Middle | 270~290° C. |
| | Rear | 290~300° C. |

| | |
|---|---|
| Nozzle temperature | 290~310° C. |
| Mold temperature | 60~130° C. |
| Injection pressure | 600~1,100 kg/cm² |
| Screw speed | 40~100 rpm |

### Experimental Example 1

### SAR Measurement

The mobile phone case prepared in Preparative example was measured for specific absorption rate (SAR) and call sensitivity. For comparison, the mobile phone case (Comparative example) prepared in the conventional method was measured for specific absorption rate (SAR) and call sensitivity in the same manner as the above.

The SAR measurement method and conditions used in the present invention are as follows.

TX-25B (BAR type)

TEST MODE: AMPS (835 MHz)

CH/Frequency: 383 (384) channel/836.490 MHz

TEST POSITION: touch 90°

TX power: 27.0 dBm

The measurement results are listed in the following Table 2.

TABLE 2

| | Standard | Comp. example | Example |
|---|---|---|---|
| Antenna - In | Korean | 1.610 | 1.490 |
| Antenna - Out | 1.6 W/kg | 0.659 | 0.647 |
| | European | | |
| | 2.0 W/kg | | |
| Call | 59 dB | 65.780 | 65.520 |
| sensitivity | | | |

As listed in Table 2, it was revealed that the mobile phone case prepared in the method according to one exemplary embodiment of the present invention has a low specific absorption rate (SAR) but a slightly low call sensitivity, compared to the mobile phone case prepared in the conventional method.

### Experimental Example 2

### Measurement of Antibacterial Activity

The mobile phone prepared in Preparative example was measured for antibacterial activities against Staphylococcus and Streptococcus, species which have been known to live in mobile phones. This experiment was carried out according to the KS K 0905 standard.

In accordance with the experimental results, it was proved that the mobile phone has 80% or more antibacterial activity against Staphylococcus, and also has 60% or more antibacterial activity against Streptococcus.

As described above, the composition for mobile phone cases according to one exemplary embodiment of the present invention may be useful to show an excellently beneficial electromagnetic shielding effect without any significant loss in call sensitivity by selectively absorbing a certain frequency range using a ferrite having a predetermined initial permeability. Also, the composition for mobile phone cases may be useful to contribute to the ease of manufacturing light-weight products since the composition has the excellent effect on the reduction of SAR, even when a small amount of the ferrite is added to the composition.

The composition for mobile phone cases according to one exemplary embodiment of the present invention may be useful to have an antibacterial effect because a cationic ferrite is used in the composition, which renders it possible to prevent the surface of the mobile phone case from being contaminated by bacteria.

Meanwhile, the method of manufacturing a mobile phone case according to one exemplary embodiment of the present invention has the advantage of a short manufacturing time, a low product inferiority rate and inexpensive manufacturing costs because it does not need a multi-step EMI process.

Furthermore, the method of manufacturing a mobile phone case according to one exemplary embodiment of the present invention has the advantages that waste by-products, volatile organic compounds and the like, which cause the environmental pollution and are harmful to human beings, are not generated.

While the present invention has been shown and described in connection with the exemplary embodiments, it will be apparent to those skilled in the art that modifications and variations can be made without departing from the spirit and scope of the invention as defined by the appended claims.

What is claimed is:

1. A composition for mobile phone cases, comprising 70 to 97% by weight of a thermoplastic resin selected from the group consisting of polycarbonate (PC), acrylonitrile-butadiene-styrene (ABS), polybutyrene terephtalate (PBT), acrylic resin and combinations thereof; and 3 to 30% by weight of a ferrite selected from the group consisting of nickel-zinc ferrite, manganese-magnesium ferrite, manganese-zinc ferrite, copper-zinc ferrite, manganese-magnesium-aluminum ferrite, yttrium iron garnet (YIG) ferrite and combinations thereof,
wherein the composition is a pellet resin formed by extruding the thermoplastic resin and the ferrite at a high temperature of 160 to 290° C.

2. The composition of claim 1, wherein the ferrite has an initial permeability of 100μ to 1000μ.

3. The composition of claim 1, further comprising 0.1 to 10% by weight of an elastomer.

4. A method of manufacturing a mobile phone case, comprising:
preparing a pellet resin composition by extruding a thermoplastic resin and a ferrite at a high temperature; and
injection-molding the pellet resin composition at a temperature of 180 to 310° C.

5. The method of claim 4, further comprising: coating an outer layer of the mobile phone case with a polymer resin having an anti-static effect and colors after the injection molding step.

6. A method of manufacturing a mobile phone case, comprising:
preparing a thermoplastic resin composition used to form an outer layer of a mobile phone case;
preparing a pellet resin composition used to form an inner layer of the mobile phone case by extruding 70 to 97% by weight of a thermoplastic resin and 3 to 30% by weight of a ferrite at a high temperature of 160 to 290° C.; and
subjecting the thermoplastic resin composition and the pellet resin composition to a double injection molding process.

7. The method of claim 6, wherein the thermoplastic resin composition used to form the outer layer of the mobile phone case comprises an antistatic agent, a pigment or a combination thereof.

8. The method of claim 6, wherein the thermoplastic resin composition used to form the outer layer of the mobile phone case is transparent, and the mobile phone case is formed integrally with a window in the double injection molding step.

9. The method of claim 6, wherein the double injection molding is carried out at a temperature of 180 to 310° C.
